(19) United States
(12) Patent Application Publication
(10) Pub. No.: US 2006/0005858 A1
(43) Pub. Date: Jan. 12, 2006

(54) Filter back-flushing and rinsing device

(76) Inventor: Gene Deveraux, Billings, MT (US)

Correspondence Address: Antoinette M. Tease, P.L.L.C., PO Box 51016, Billings, MT, 59105, US

(21) Appl. No.: 10/887,651

(22) Filed: Jul. 9, 2004

(51) Int. Cl. B08B 9/00; B08B 3/00

(52) U.S. Cl. 134/22.1; 134/34; 134/166 R; 134/184; 134/104.2; 134/10

(57) ABSTRACT

An apparatus for cleaning, back-flushing and rinsing a filter comprising a holding tank, a lower compartment, one or more perforated armatures, one or more filters, and one or more screw caps. The lower compartment comprises one or more threaded receivers, and the perforated armatures screw into the threaded receivers. The lower compartment further comprises an inlet and a main drain and is sealed so that water entering the lower compartment through the inlet can only travel out the main drain or up through the threaded receivers and perforated armatures. Each filter is placed over a perforated armature, and a screw cap is placed on top of each filter to hold it in place. The holding tank comprises one or more overflow drains, handles and a lid. A method of using the apparatus described above to clean a filter.

### BACKGROUND OF THE INVENTION

1. Field of the Invention

The present invention relates to the field of spa filter cleaning devices, and more particularly to a spa filter cleaning device that allows the spa filter to be back-flushed and rinsed in the same container, without removing the spa filter.

2. Description of the Related Art

U.S. Pat. No. 5,042,516 (Chaney, 1991) provides a filter washing apparatus comprised of a tank with a submersible pump and a large perforated tube affixed to the bottom of the tank. Inside of the large perforated tube is a small perforated tube. Water and cleaning solution is poured into the tank, and then the pump sucks up the water and cleaning solution and drives it through the small perforated tube into the large perforated tube and out into the rest of the tank. The cycle continues until the back-flushing process has been completed, and the filter is then removed so that it can be rinsed with a garden hose. There is no explanation as to how the oils and debris that are removed from the filter through the back-flushing process are removed from the tank. In contrast to the Chaney invention, the present invention allows the filter to be both back-flushed and rinsed within the same compartment, and it also provides a mechanism for removing the oils and debris from the tank in which the back-flushing process takes place. Unlike the Chaney invention, the present invention can be used without a source of power, and it provides a much simpler design for accomplishing the same purpose as the Chaney invention.

U.S. Pat. No. 6,575,180 (Jelten et al., 2003) discloses a spa filter cleaning and rinsing device that comprises a rectangular-shaped base, a perforated armature (or arm) that protrudes upward from one end of the base at an angle, and spray jets that are affixed to an upwardly protruding portion of the base. The filter to be cleaned is placed over the armature, and water is sprayed through the holes in the armature to accomplish the back-flushing of the filter. There is no mechanism for holding the filter onto the armature other than the angle of the armature, and there is no provision for preventing the water from coming out the ends of the filter rather than flushing through it. At the same time that water is sprayed out through the perforated armature to accomplish the back-flushing action, water is also sprayed through the spray jets directly at the filter, causing it to rotate or spin on the armature. Thus, the filter is purportedly spinning at the same time that it is being back-flushed. There is no explanation as to how the water from the spray jets or the water that is used to back-flush the filter is contained. Moreover, the Jelten invention is concerned only with rinsing and spinning the filter, and it does not address the actual cleaning process where cleaning solution is used.

### BRIEF SUMMARY OF THE INVENTION

The present invention is an apparatus for cleaning, back-flushing and rinsing a filter in a single compartment without having to remove the filter at each step. The apparatus comprises a holding tank, a lower compartment, and one or more perforated armatures. The lower compartment comprises one or more threaded receivers, the number of perforated armatures corresponds to the number of threaded receivers, and the perforated armatures screw into the threaded receivers. The lower compartment further comprises an inlet and a main drain, and the lower compartment is sealed so that water entering the lower compartment through the inlet can only travel out the main drain or up through the threaded receivers and perforated armatures. The apparatus of the present invention further comprises one or more filters and one or more screw caps. Each filter is placed over a perforated armature, and a screw cap is placed on top of each filter to hold it in place on the perforated armature.

The holding tank comprises one or more overflow drains, which are located on the outside of the holding tank at a level that is higher than the top of the screw cap(s). The holding tank also comprises a lid and a means for attaching the lid to the holding tank. The holding tank comprises handles that are preferably located on the outside of the holding tank.

The present invention also covers a method of using the apparatus described above to clean a filter.

### BRIEF DESCRIPTION OF THE DRAWINGS

FIG. 1 is a perspective view of a preferred embodiment of the present invention.

FIG. 2 is a side view of a preferred embodiment of the present invention.

FIG. 3 is a top view of a preferred embodiment of the present invention.

FIG. 4 is a cross-section view of a preferred embodiment of the present invention.

### REFERENCE NUMBERS

1 Holding tank
2 Lower compartment
3 Inlet
4 Main drain
5 Threaded receiver
6 Overflow drain
7 Handle
8 Lid
9 Hinges
10 Perforated armature
11 Filter
12 Screw cap

### DETAILED DESCRIPTION OF INVENTION

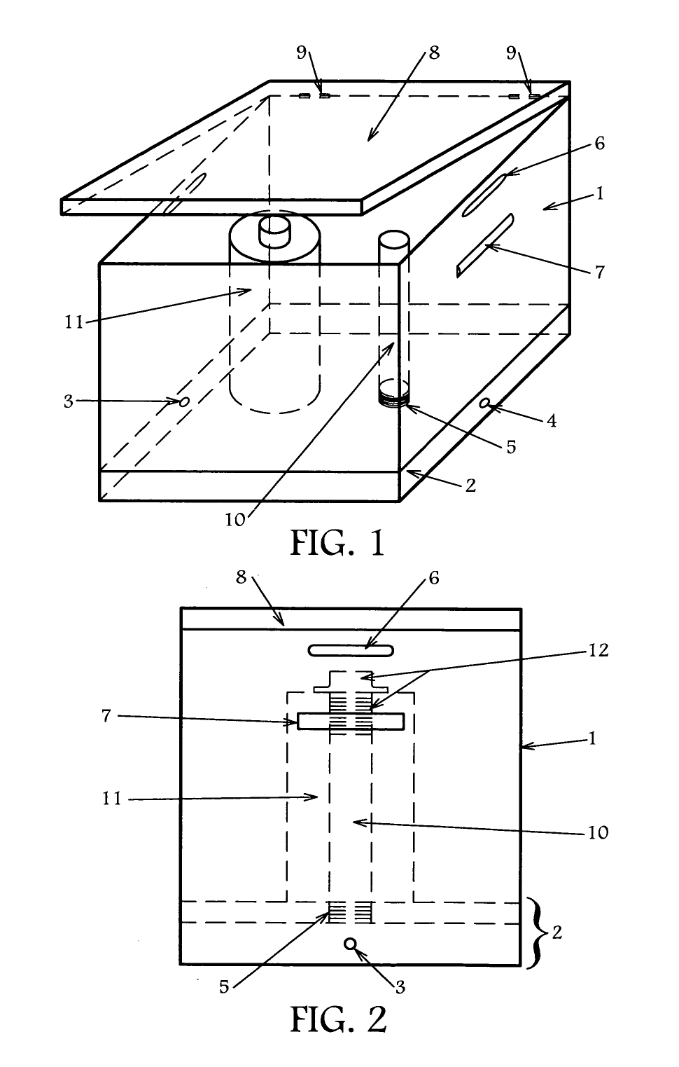

FIG. 1 is a perspective view of a preferred embodiment of the present invention. As shown this figure, the present invention comprises a holding tank 1 with a lower compartment 2. The lower compartment comprises an inlet 3 and a main drain 4. The inlet 3 is optionally threaded so that a hose can be screwed into the inlet 3. The main drain 4 includes a removable plug (not shown) that allows the main drain 4 to be opened and closed. The lower compartment 2 further comprises one or more threaded receivers 5 in the top of the lower compartment 2. The threaded receivers 5 extend downward from the top of the lower compartment 2, but they do not extend all the way to the bottom of the lower compartment 2 (see FIGS. 2 and 4). The bottom of the threaded receivers 5 is open to the rest of the lower compartment 2, which allows water to flow from the lower compartment 2 into the threaded receivers 5.

On two sides of the holding tank 1 there are overflow drains 6. Directly beneath the overflow drains 6 are handles 7 for carrying the holding tank 1. There is a lid 8 on top of the holding tank 1, and the lid 8 is attached to the holding tank 1 with a plurality of hinges 9.

A perforated armature 11 is screwed into each of the threaded openings 5 in the top of the lower compartment 2. The perforated armatures 11 are detachable for cleaning or replacement purposes, and they are threaded on both ends. The lower compartment 2 is sealed so that water entering into the lower compartment 2 can only exit through the main drain 4, if the main drain 4 is open, or through the threaded receivers 5 and up into the perforated armatures 11, if the main drain is closed 4. A filter 12 is placed onto each perforated armature 11. The size of the perforated armatures 11 and threaded receivers 5 can vary to fit any spa, hot tub or Jacuzzi filter.

The number of perforated armatures 11 and threaded receivers 5 can also vary depending upon the particular end use, and the present invention is not limited to any specific number of perforated armatures 11 or threaded receivers 5. For example, a large holding tank 1 with numerous perforated armatures 11 and threaded receivers 5 could be designed for a spa dealer that cleans several of its customers' filters at one time. A smaller, more portable embodiment could be constructed with only one perforated armature 11 and threaded receiver 5 for home use. The present invention covers any number of perforated armatures 11 and threaded receivers 5.

FIG. 2 is a side view of a preferred embodiment of the present invention. This figure shows the holding tank 1, the lower compartment 2, and the inlet 3. The main drain 4 (not shown) is opposite the inlet 3. This figure also shows the threaded receivers 5 that extend from the top of the lower compartment 2 and that are open to the rest of the lower compartment 2 to allow water to pass from the lower compartment 2 up into the threaded receivers 5 and perforated armatures 11. As illustrated in this figure, a screw cap 13 is placed on top of the filter 12 to hold the filter in place during the cleaning and rinsing process. The screw cap 13 also ensures that water passing up through the perforated armatures 11 will travel through the filter itself and not out either end of the filter 12. As is shown in FIG. 2, the filter 12 and screw cap 13 are situated beneath the overflow drain 6.

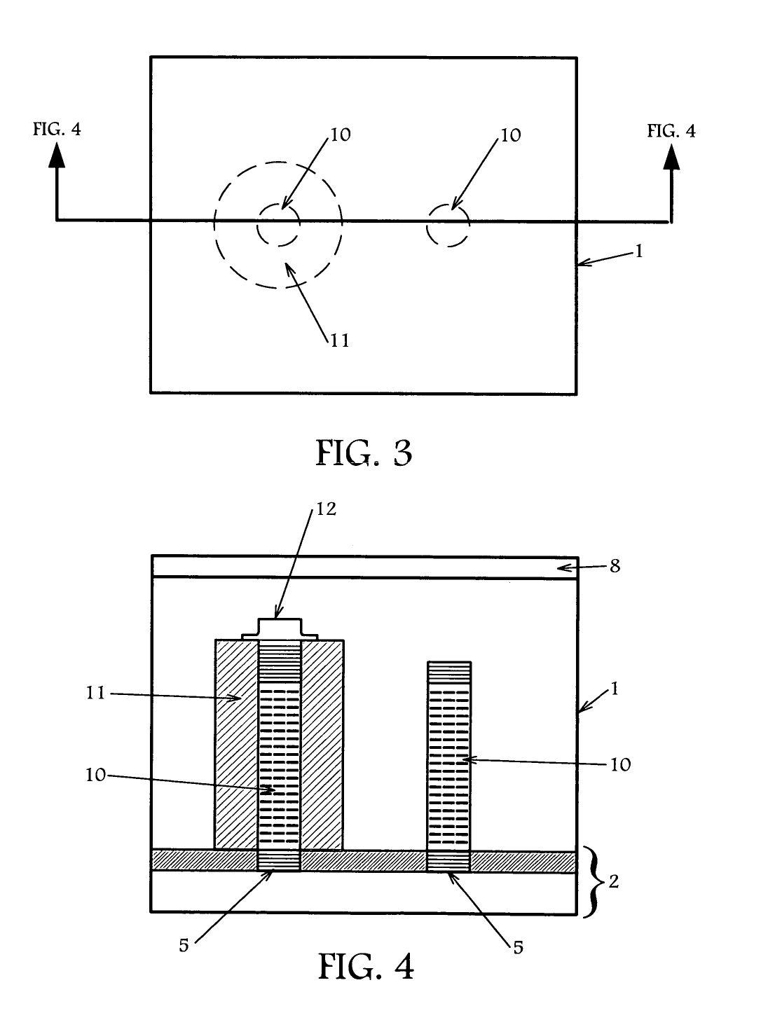

FIG. 3 is a top view of a preferred embodiment of the present invention. This figure shows the orientation of the filter 12 on the perforated armature 11 in an embodiment that has only two perforated armatures.

FIG. 4 is a cross-section view of a preferred embodiment of the present invention taken at the line shown in FIG. 3. This figure shows the holding tank 1, the lower compartment 2, the threaded receivers 5, the lid 8, the perforated armatures 11, the filter 12 and the screw cap 13. Although FIGS. 1, 3 and 4 show a filter 12 on only one of the perforated armatures 11, there would typically be a filter 12 on each perforated armature 11.

The present invention works as follows: first, the perforated armatures 11 are screwed into the threaded receivers 5. Second, the filters are placed over the perforated armatures 11. Third, a screw cap 13 is screwed onto the top of each perforated armature 11 to hold the filter in place 12. The main drain 4 and lid 8 are closed, and a garden hose is screwed into the inlet 3. The holding tank 1 is filled with water to just beneath the overflow drain 6. This can be accomplished by injecting water into the lower compartment and up through the perforated armatures through the inlet, or water could also be poured into the tank from the top of the holding tank. Optionally, a water pump can be attached to the inlet 3 to facilitate filling the holding tank 1 with water, although the pump is not essential to the operation of the present invention.

By filling the tank to just beneath the overflow drain 6, the filters 12 are covered with water, but the water is not high enough to flow out the overflow drain 6. Cleaning solution is added to the holding tank, and the filters are allowed to soak in the diluted cleaning solution for 24 hours or whatever time period is prescribed by the particular cleaning product.

After the filters 12 have soaked in the cleaning solution for the prescribed period of time, the cleaning solution is drained from the holding tank 1 through the main drain 4, and then water is injected into the lower compartment 2 through the inlet 3. This can be accomplished simply by turning the garden hose on, or a water pump can be attached to the inlet to provide greater pressure. The water travels through the threaded receivers 5, up through the perforated armatures 11 and out through the filters 12. This action causes the filters to be back-flushed and oil and debris to be removed from the filters and flushed out into the water in the holding tank 1. At this step, the water is allowed to flow out the overflow drain 6. The oils will rise to the surface of the water and will flow out the overflow drain 6 with the excess water.

When the filters 12 have been back-flushed for a sufficient period of time, the water is turned off, the main drain 4 is opened, and the rest of the water can be removed through the main drain 4. Once all of the water from the back-flushing process has been removed from the holding tank 1 and lower compartment 2, the main drain 4 is closed again, clean water is injected into the lower compartment 2 through the inlet 3, and the filters are rinsed as the water passes up through the perforated armatures 11 and out the filters 12. As with the back-flushing process, water is allowed to flow out the overflow drain 6, and when the rinsing process has been completed, the water is turned off, and any remaining water is drained out of the main drain 4. The screw caps 13 and filters 12 are removed, and the perforated armatures 11 can also be removed if necessary.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. An apparatus for back-flushing and cleaning filters, comprising:
(a) a holding tank;
(b) a lower compartment;
(c) one or more perforated armatures;
wherein the lower compartment comprises one or more threaded receivers,
wherein the number of perforated armatures corresponds to the number of threaded receivers, wherein the perforated armatures screw into the threaded receivers, wherein the lower compartment comprises an inlet and a main drain, and wherein the lower compartment is sealed so that water entering the lower compartment through the inlet can only travel out the main drain or up through the threaded receivers and perforated armatures.

2. The apparatus of claim 1, further comprising one or more filters and one or more screw caps, wherein each filter is placed over a perforated armature, and wherein a screw cap is placed on top of each filter to hold it in place on the perforated armature.

3. The apparatus of claim 2, wherein the holding tank comprises one or more overflow drains.

4. The apparatus of claim 3, wherein the overflow drains are located on the outside of the holding tank at a level that is higher than the top of the screw cap(s).

5. The apparatus of claim 1, wherein the holding tank comprises a lid and a means for attaching the lid to the holding tank.

6. The apparatus of claim 5, wherein the means for attaching the lid to the holding tank is a plurality of hinges.

7. The apparatus of claim 1, wherein the holding tank comprises one or more handles.

8. The apparatus of claim 7, wherein the handles are located on the outside of the holding tank.

9. The apparatus of claim 1, wherein the perforated armatures are detachable.

10. A method of using the apparatus of claim 4 to clean a filter, comprising the steps of:
(a) screwing the perforated armature(s) into the threaded receivers;
(b) placing a filter over each perforated armature;
(c) placing a screw cap on top of each perforated armature to hold the filter in place;
(d) closing the main drain;
(e) attaching a water supply to the inlet;
(f) filling the holding tank with water from the inlet to just beneath the overflow drain;
(g) adding cleaning solution to the holding tank;
(h) allowing the filters to soak in the cleaning solution for whatever period of time is prescribed by the particular cleaning solution used;
(i) injecting water into the lower compartment through the inlet for a period of time sufficient to back-flush the filter(s);
(j) turning the water supply off;
(k) opening the main drain until all the water has been drained from the holding tank and lower compartment;
(l) closing the main drain;
(m) injecting water into the lower compartment through the inlet;
(n) allowing the water to pass up through the threaded receivers and perforated armatures and out through the filters for a period of time sufficient to rinse the filters;
(o) turning the water off;
(p) draining any remaining water out of the main drain;
(q) unscrewing the screw cap(s); and
(r) removing the cleaned filter(s).
